(19) United States
(12) Patent Application Publication
(10) Pub. No.: US 2016/0238789 A1
(43) Pub. Date: Aug. 18, 2016

(54) Compact optical fiber splitters

(71) Applicant: Mellanox Technologies Ltd., Yokneam (IL)

(72) Inventors: Rafi Lagziel, Modiin (IL); Nimer Khazen, Ba'ne (IL); Shmuel Levy, Kiryat Tivon (IL)

(21) Appl. No.: 15/137,048

(22) Filed: Apr. 25, 2016

Related U.S. Application Data
(63) Continuation-in-part of application No. 13/851,178, filed on Mar. 27, 2013, now abandoned.

(51) Int. Cl. G02B 6/28; G02B 6/125; G02B 6/136; G02B 6/32; G02B 6/30; G02B 6/42; G02B 6/38

(52) U.S. Cl. CPC G02B 6/2817; G02B 6/4292; G02B 6/125; G02B 6/3885; G02B 6/32; G02B 6/30; G02B 6/136; G02B 6/3882; G02B 2006/12104

(57) ABSTRACT

An apparatus includes one or more optical waveguides, one or more first micro-lenses, and one or more second micro-lenses. The one or more optical waveguides are formed in a substrate and are configured to convey respective optical signals between first ends and second ends of the optical waveguides. The one or more first micro-lenses are disposed on the respective first ends of the optical waveguides and are configured to couple the optical signals between the first ends and respective first optical elements. The one or more second micro-lenses are disposed on the respective second ends of the optical waveguides and are configured to couple the optical signals between the second ends and respective second optical elements.

### RELATED APPLICATIONS

The present application is a continuation in part of U.S. patent application Ser. No. 13/851,178, filed Mar. 27, 2013, and published as US patent publication 2014/0294339, the disclosure of which is incorporated herein by reference.

### FIELD OF THE INVENTION

The present invention relates generally to optical components, and particularly to compact optical fiber splitters.

### BACKGROUND

US Patent Application Publication 2010/0158446 to Ohta describes an optical path turning device.

US Patent Application Publication 2004/0114866 to Hiramatsu describes an optical path changing connector.

### SUMMARY

An embodiment of the present invention described herein provides an optical interconnect to direct optical signals between first and second ferrules of optical fibers, comprising a substrate, a first optical interface, configured to connect to the first ferrule of optical fibers, located on a first face of the substrate, a second optical interface, configured to connect to the second ferrule of optical fibers, located on a second face of the substrate, a plurality of optical waveguides, which are formed in the substrate and are configured to convey respective optical signals between the first optical interface and the second optical interface, one or more first micro-lenses, which are disposed on respective first ends of the optical waveguides and are configured to couple the optical signals between the first ends and the first ferrule and one or more second micro-lenses, which are disposed on respective second ends of the optical waveguides and are configured to couple the optical signals between the second ends and the second ferrule. Optionally, each of the plurality of waveguides includes at least one horizontal bend and wherein the at least one horizontal bends of the plurality of waveguides are included in a single plane.

There is further provided an apparatus including one or more optical waveguides, one or more first micro-lenses, and one or more second micro-lenses. The one or more optical waveguides are formed in a substrate and are configured to convey respective optical signals between first ends and second ends of the optical waveguides. The one or more first micro-lenses are disposed on the respective first ends of the optical waveguides and are configured to couple the optical signals between the first ends and respective first optical elements. The one or more second micro-lenses are disposed on the respective second ends of the optical waveguides and are configured to couple the optical signals between the second ends and respective second optical elements.

In some embodiments, the first micro-lenses are disposed on a face of the substrate, and the first ends of the optical waveguides terminate at a predefined distance from the face of the substrate, opposite the first micro-lenses. In other embodiments, the first and second optical elements include at least one element type selected from a group of types consisting of optical fibers, optical detectors and optical emitters. In yet other embodiments, the apparatus also includes a mechanical fixture that fixes the first optical elements at a predefined distance from the respective first micro-lenses, so as to form an air gap between the first optical elements and the first micro-lenses.

In some embodiments, each optical waveguide includes a respective bending element that bends an optical signal in the optical waveguide between a first axis and a second axis. In other embodiments, the optical waveguides include first and second subsets of the optical waveguides, such that the first ends of the optical waveguides in the first subset are arranged in a first row, and the first ends of the optical waveguides in the second subset are arranged in a second row positioned above the first row. In yet other embodiments, the first and second subsets of the optical waveguides lie in first and second different parallel planes.

In some embodiments, the optical waveguides include a first subset of the optical waveguides whose second ends lie on a first face of the substrate, and a second subset of the optical waveguides whose second ends lie on a second face of the substrate, different from the first face. In other embodiments, the first face is parallel with the second face. In yet other embodiments, the first face is perpendicular to the second face.

There is additionally provided, in accordance with an embodiment of the present invention, an apparatus, which includes an optical interconnect, which includes a substrate, one or more optical waveguides, one or more first micro-lenses, one or more second micro-lenses, and first and second mechanical fixtures. The one or more optical waveguides are formed in a substrate and are configured to convey respective optical signals between first ends and second ends of the optical waveguides. The one or more first micro-lenses are disposed on the respective first ends of the optical waveguides and are configured to couple the optical signals between the first ends and respective first optical elements. The one or more second micro-lenses are disposed on the respective second ends of the optical waveguides and are configured to couple the optical signals between the second ends and respective second optical elements. The first and second mechanical fixtures are configured to fix the first and second optical elements against the first and second ends of the optical waveguides, respectively.

In some embodiments, the first optical elements include optical fibers, and the first mechanical fixture includes a ferrule that is configured to fix respective facets of the optical fibers to the respective first ends of the optical waveguides. In other embodiments, the first mechanical fixture is configured to fix the first optical elements at a predefined distance from the respective first micro-lenses, so as to form an air gap between the first optical elements and the first micro-lenses.

There is additionally provided, in accordance with an embodiment of the present invention, a method including forming one or more optical waveguides in a substrate, for conveying respective optical signals between first ends and second ends of the optical waveguides. One or more first micro-lenses are disposed on the respective first ends of the optical waveguides, for coupling the optical signals between the first ends and respective first optical elements. One or more second micro-lenses are disposed on the respective second ends of the optical waveguides, for coupling the optical signals between the second ends and respective second optical elements.

The present invention will be more fully understood from the following detailed description of the embodiments thereof, taken together with the drawings in which:

### BRIEF DESCRIPTION OF THE DRAWINGS

FIG. 1 is a diagram showing an optical interconnect with integrated micro-lenses, in accordance with an embodiment of the present invention;

FIGS. 2A-2D are diagrams showing different reflector configurations for a bend in an optical waveguide, in accordance with embodiments of the present invention;

FIGS. 3A and 3B are diagrams showing a T-shaped optical splitter module, in accordance with an embodiment of the present invention;

FIGS. 4A and 4B are diagrams showing an L-shaped optical splitter module, in accordance with an embodiment of the present invention;

FIGS. 5A-5C are diagrams showing three optical splitter module configurations, in accordance with embodiments of the present invention; and

FIG. 6 is a diagram showing an optical interconnect with a light monitor, in accordance with an embodiment of the invention.

### DETAILED DESCRIPTION OF EMBODIMENTS

### Overview

Many optical systems use optical fibers to couple light between different optical elements. In some systems, individual fibers are held in a bundle, or optical cable, and need to be separated to route the fibers to optical elements at different locations in the system. For example, an optical fiber splitter module may be used to physically separate and bend the individual fibers in the fiber cable into two or more different output fiber cables in a very small module volume, in order to route the fibers to their destination in the system. As the number of fibers in the bundle increase, the size of the splitter increases accordingly to accommodate the density of fibers. This constraint limits reducing the size of the splitter, whereas space constraints are sometimes critical and require modules with small form factors.

Embodiments of the present invention described herein provide highly compact optical interconnects, and methods for fabricating such interconnects as building blocks for optical splitter modules. In the disclosed embodiments, optical signals in one or more optical fibers are coupled through an optical interface with integrated micro-lenses to an array of compact waveguides formed in a substrate. The micro-lenses are configured to focus or collimate the light efficiently between the individual fiber and respective waveguides in the substrate.

Once the light is coupled into the waveguide array in the substrate, the separate waveguides are bent horizontally or vertically in the substrate. A portion of the waveguides in the array can be split and routed to any desired face of the substrate. The waveguides can be routed in a very small form factor to another micro-lens interface at the other end of the waveguide array.

One or more micro-lens based optical interfaces can be located on any face of the substrate to couple light between a first cable to any number of fiber in one or more cables using a multi-level waveguide substrate. Thus in additional embodiments described herein, a variety low-loss optical splitter module configurations and topologies with highly compact form factors, are shown based on the micro-lens based optical interconnect building block.

As mentioned above, in some embodiments of the invention, a plurality of the waveguides are bent horizontally, such that the bend areas of the plurality of waveguides are included in a single plane. In some embodiments, the waveguides are entirely planar within the substrate. In these embodiments, interfaces to the waveguides in the substrate on opposite sides of the waveguides are also included in the same plane as the waveguides. In other embodiments, the waveguides are both horizontally and vertically bent within the substrate, allowing the interfaces to the waveguides to be located in different planes.

In some embodiments, all the waveguides connecting a pair of interfaces have the same length within the plane of the bend and extend parallel each other. Optionally, each of the waveguides includes at least two bends, which are arranged such that the waveguides are parallel each other when connecting to the interfaces.

In other embodiments, the waveguides connecting a pair of interfaces have different lengths according to their relative positions at the bend location. Generally, the waveguide in an inner part of the bend is shorter than the waveguide at the outer part of the bend.

The use of horizontal bends allows more flexibility in the arrangement of the waveguides and can achieve a more compact fiber splitter.

### System Description

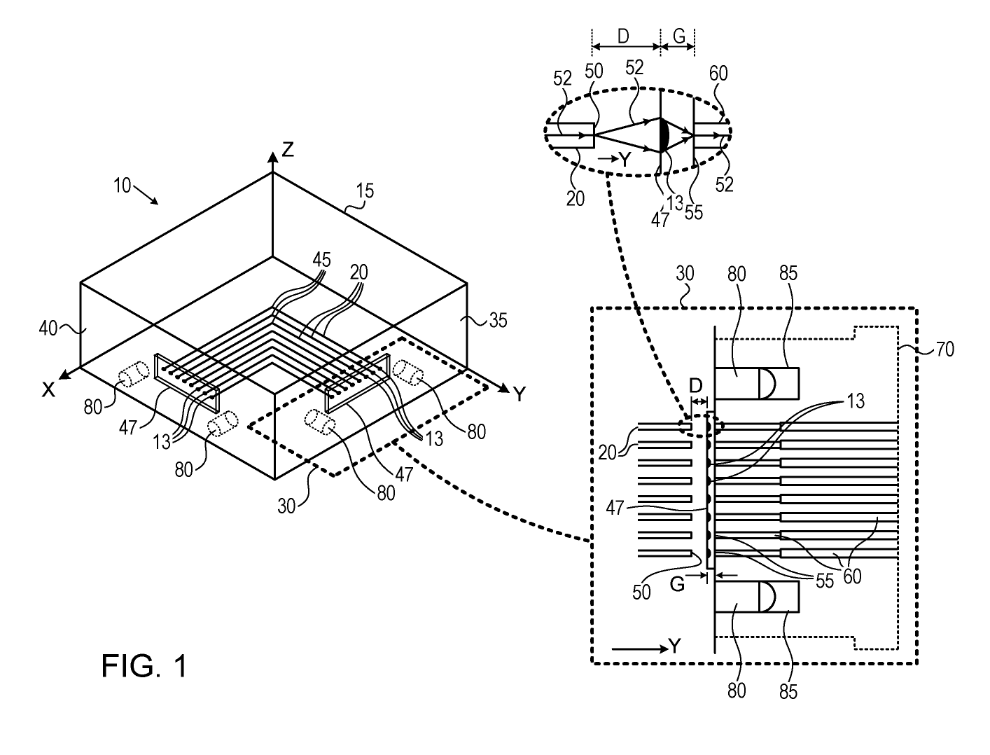

FIG. 1 is a diagram showing an optical interconnect 10 with integrated micro-lenses 13, in accordance with an embodiment of the present invention. Optical interconnect 10 comprises a lateral array of eight optical waveguides 20 formed in a substrate 15 which terminate with eight respective integrated micro-lenses 13 on either side.

Waveguides 20 have an orientation vector that is perpendicular to the cross-section of waveguides 20. An optical interface 30 is formed on a face 35 of substrate 15 as shown in the dashed region in FIG. 1. A similar optical interface is also formed on a face 40 of substrate 15 (not shown in FIG. 1). Light is coupled in waveguides 20 between the two respective optical interfaces on face 35 and face 40 through bends 45 in optical waveguides 20. The orientation vector of waveguides 20 on face 35 is directed parallel to the Y-axis in the XY plane in FIG. 1. The orientation vector rotates to become parallel to the X-axis in the XY plane in bend 45 as waveguides 20 connect into the optical interface on face 40.

As shown in the first inset for optical interface 30, waveguides 20 terminate on a waveguide end 50 positioned at a distance D from a trench face 47 formed in face 35 of the substrate 15. The trench causes the light to traverse a distance of D through the substrate material, between ends 50 of waveguides 20 and trench face 47. An optical material is disposed on trench face 47 at faces 35 and 40 at a distance D from end 50 of each waveguide 20 to form an array of integrated micro-lenses 13. Each micro-lens 13 in the array is configured to focus a light ray 52 diverging from waveguide end 50 onto an optical element, such an optical fiber facet 55 of an optical fiber 60, as shown both in the first and second insets of FIG. 1. Facet 55 is positioned at a distance G from trench face 47.

In some embodiments, substrate 15 may comprise one or more layers of optical materials, such as polycarbonate (PC), polystyrene (PS), silica, and poly-methyl methacrylate (PMMA). Waveguides are formed by etching grooves in the one or more layers, filling the etched grooves with a second optical material with a higher index of refraction than that of the one or more layers, and bonding the one or more layers together to form substrate 15. In the exemplary configuration of eight parallel waveguides 20 shown in FIG. 1, to form an array of waveguides 20 with two layers of optical material, the filled groove layers on the top layer are aligned and bonded to mirroring filled grooves on the bottom layer to form substrate 15.

Any suitable cross-sectional shape of waveguide 20 can be created in this manner, which depends on the etching process that determines the shape of the etched grooves. Moreover, one or more layers of stacked waveguides can be formed in this manner as will be shown further below. In other embodiments, the waveguides can be directly formed with conventional lithography processes used, for example, in silicon complementary metal oxide semiconductor (CMOS) processes or processes to form Si Micromechanical Systems (MEMS) devices.

Micro-lenses 13 can be formed opposite waveguide ends 50 on trench face 47 using fabrication techniques, such as injection molding of polyetherimide (PEI), or other techniques that are known in the art for disposing suitable material on trench face 47 to form micro-lenses 13. In some embodiments, micro-lenses 13 are designed to filter light in addition to focusing the light. For example, micro-lenses 13 may be produced by a material which filters specific wavelengths and/or micro-lenses 13 are tinted to attenuate the light intensity. Alternatively or additionally, an additional glass window is positioned in front of the micro-lenses 13 to perform the filtering.

Optical fibers 60 are typically held in micro-channels formed in a ferrule 70, which is shown in a dotted outline in the first inset of FIG. 1. Optical fibers 60 are typically multi-mode fibers with diameters as follows: a core diameter ranging from 50-62.5 μm, a surrounding cladding layer diameter of 125 μm, and an outer mechanical coil diameter ranging from 250-900 μm. These sizes, however, are given purely by way of example, and any other suitable sizes can be used.

In some embodiments, guide pins 80 are formed on face 35 and face 40 to hold ferrule 70 at each face by inserting guide pins 80 into guide pin channels 85 formed in the body of ferrule 70. An array of fiber facets 55 can then be placed precisely at a gap distance G from an array of respective micro-lens 13, i.e., so as to form an air gap of width G between the fiber ends and the corresponding micro-lenses.

Typically an optical fiber cable is connected and supported at a first end of the ferrule. The individual fibers from the cable are thread through and held in separate micro-channels formed in the body of the ferrule. At a second (opposite) end of the ferrule, the ends of the fibers coupling light into optical interface 30 are typically cleaved or polished fiber facets 55 that are aligned with the edge of ferrule 70 as shown in the first inset of FIG. 1.

Examples of ferrules are MT Ferrules produced by Connected Fibers, Inc. (Roswell, Georgia). A datasheet of such MT ferrules, entitled “MT ferrules,” January, 2009, is incorporated herein by reference. International Electrotechnical Commission (IEC) document number IEC61754-5, entitled “Fiber Optic Connector Interfaces—Part 5: Type MT Connector Ferrules,” January, 1996, which is incorporated herein for reference, specifies such ferrule designs. Fiber facets 55 align with the second end of ferrule 70 which connects to the module. The arrangement of the fiber facets at the edge of the ferrules can have different footprints. For example, a ferrule holding twenty-four fibers can be arranged in a footprint of two rows of twelve fibers separated by a predefined distance.

In the embodiment of FIG. 1, eight waveguides connect the interface trench faces 47 on faces 35 and 40 of substrate 15. The most inner waveguide is shortest and each following waveguide is longer than the previous waveguide. It is noted that the rightmost waveguide on face 35 corresponds to the leftmost waveguide on face 40 and vice versa. While eight waveguides are shown in substrate 15 connecting the interface trench faces 47 on faces 35 and 40, substrates in accordance with embodiments of the present invention may include other numbers of waveguides, including more than 10 or even more than 20 waveguides.

The coupling efficiency of light between waveguide 20 and fiber 60 at both faces 35 and 40 of interconnect 10 may be optimized empirically, or by simulation. This optimization is done by varying parameters, such as gap distance G, distance D, the shape of micro-lens 13, the shape of waveguide bends 45, and any other suitable geometrical or material parameter in optical interconnect 10. Stated differently, light exiting the waveguide should be matched into the fiber core with a given numerical aperture by varying the above parameters so as to focus the light diverging from waveguide end 50 onto fiber facet 55. The precision positioning of fiber facets 55 relative to trench face 47 using ferrule guide pins 85 is also an important parameter affecting the overall optical loss in interconnect 10.

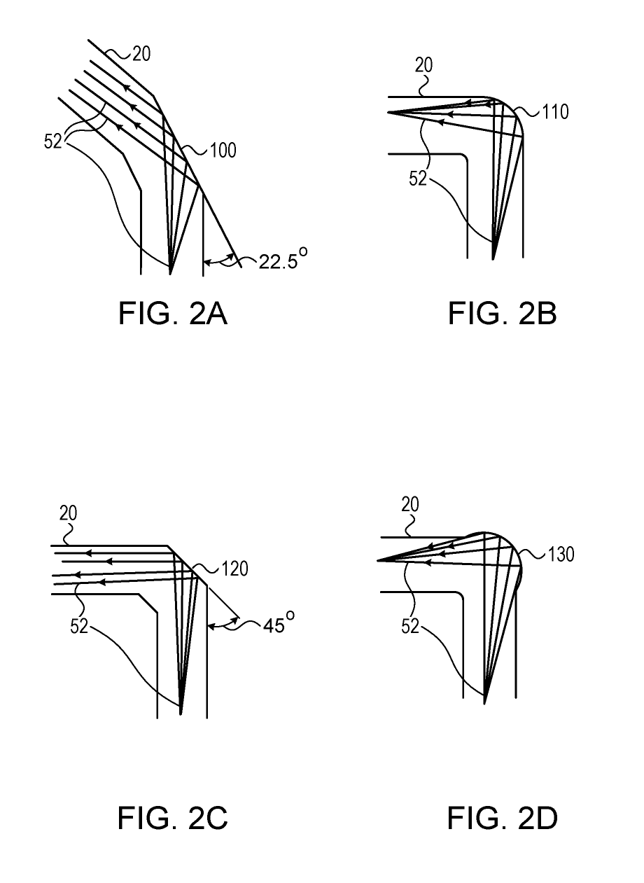

FIGS. 2A-2D are diagrams showing different reflector configurations for optical waveguide bend 45, in accordance with embodiments of the present invention. The configuration of waveguide bend 45 is also important for minimizing optical losses of light ray 52 in bend 45 propagating in waveguide 20, which in turn is an important parameter in the design of optical interconnect 10.

FIG. 2A shows a 45-degree straight optical reflector 100 in waveguide 20. FIG. 2B shows a 90-degree curved concave optical reflector 110 in waveguide 20. FIG. 2C shows a 90-degree straight optical reflector 120 in waveguide 20. FIG. 2D shows a 90-degree parabolic optical reflector 130 in waveguide 20. The bending reflector configurations shown in FIGS. 2A-2D can be formed, for example, by etching, plating a reflecting layer, by placing a reflecting device in the etched groove of the waveguide, or by any suitable fabrication method for forming the reflector.

The optical reflector configurations shown in FIGS. 2A-2D are by way of example and not by way of limitation of the embodiments of the present invention. Any such configuration can be used for implementing bend 45 in FIG. 1, or any of the other waveguide bends shown in the figures below. For example, any suitable bend angle or reflector configuration can be used to rotate the orientation vector of the waveguide from a first axis to a second axis.

### Compact Optical Splitter and Routing Modules

A variety of optical splitter module configurations can be fabricated using optical interface 30 as a basic building block as shown in FIG. 1. Optical interconnect 10 shown in FIG. 1 comprises one row of waveguides connecting optical interface 30 on face 35 of substrate 15 oriented along the Y-axis that is bent to the same row of waveguides oriented along the X-axis which connects into the optical interface on face 40.

To realize an optical splitter module, two or more arrays of waveguides 20 shown in optical interconnect 30 may be stacked vertically. Optionally, each array of waveguides is located within a respective single plane. The input optical interface may comprise one or more rows of waveguides in the XY plane but stacked vertically at different heights along the Z-axis as shown in FIG. 1. Similarly, respective rows of micro-lens arrays may be disposed on trench face 47 at the input optical interface in the same registration as the vertically stacked waveguides so as to couple light from fibers through the micro-lenses into the stacked waveguides at the substrate edge. Each array of waveguides formed in the stacked level at a respective height along the Z-axis can then be routed away from the input optical interface to a different face of substrate 15 so as to form the core of the optical splitter module.

The exemplary embodiments of the optical splitters shown in the following figures below have a first array of micro-lenses (e.g., micro-lenses arranged in two rows) on a first edge of substrate 15 that are configured to couple light into a first and a second level of vertically stacked waveguides in the substrate. The first level of the vertically stacked waveguides is routed to a second array of respective micro-lenses formed on a second edge of the substrate, and the second level is routed to a third array of respective micro-lenses on the third edge of substrate 15.

The exemplary embodiments shown herein with eight or sixteen fibers 60 carrying light which are coupled between respective waveguides in substrate 15 through an arrays of micro-lenses 13 are shown merely for conceptual clarity and not by way of limitation whatsoever of the embodiments of the present invention. Typically, any number of fibers M*N arranged with N fibers in M rows, where M and N are integers, may be used so long as the footprint of the ferrule is configured to support the M*N fibers.

Moreover, light carried in the M*N fibers arranged in N rows and held in the ferrule should be coupled precisely to a corresponding waveguide array comprising N levels of M waveguides using a suitable multilayered substrate as described previously. However, in accordance with the embodiments of the present invention described herein, any number of fibers may be held in any suitable housing and is not limited to ferrules, which are coupled to any number of waveguides in any arrangement through respective micro-lenses.

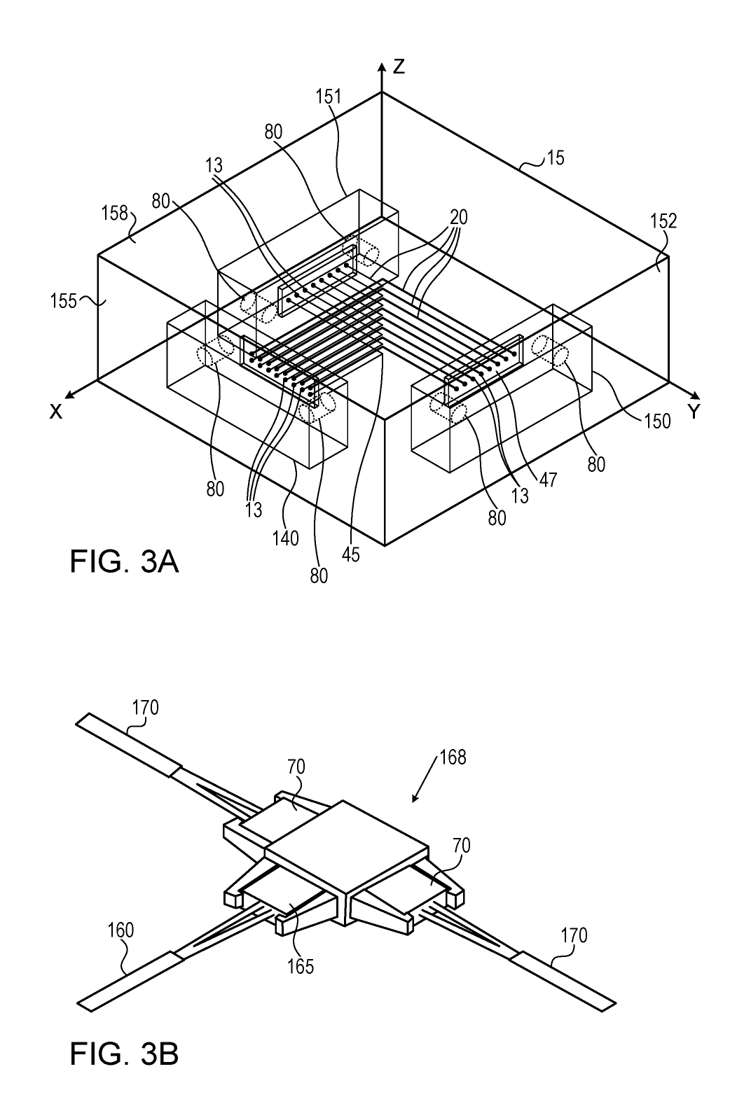

FIGS. 3A and 3B are diagrams showing a T-shaped optical splitter module 168, in accordance with an embodiment of the present invention. FIG. 3A shows substrate 15 where a cavity 140 is formed on a front face 155 of substrate 15. Similarly, two cavities 150 and 151 are formed in a right face 152 and a left face 158, respectively, of substrate 15.

FIG. 3B shows T-shaped optical splitter module 168 into which substrate 15 is placed. Cavity 140 is configured to support a multi-fiber ferrule 165 holding sixteen optical fibers that are arranged with a footprint of two rows of eight fibers within the ferrule housing supported by two ferrule guide pins 80. T-shape optical splitter module 168 shown in FIG. 3A and FIG. 3B splits sixteen fibers held in ferrule 165 on face 155 perpendicular to the X axis into two bundles of eight fibers each, held in two respective ferrules 70. The ferrules are mounted on opposite faces 152 and 158 of substrate 15, both perpendicular to the Y-axis.

Individual fibers 60 are held in optical cables. A first optical cable 160 is configured to connect to the footprint of ferrule 165. Cavities 150 and 151 are configured to support multi-fiber ferrule 70 holding eight optical fibers with a footprint of one row of eight fibers within the ferrule housing. A second optical cable 170 is configured to connect to the footprint of ferrule 70 in cavity 150 at face 152 and in cavity 151 at face 158 of substrate 15.

In some embodiments, T-shaped optical splitter module 168 shown in FIG. 3B is formed directly from substrate 15 with support pins 80, support cavities 140, 150 and 151 for the three ferrules (as shown in the example of FIG. 3A). In other embodiments, module 168 can be fabricated by forming cavities 140, 150 and 151 in any suitable housing material where substrate 15 is placed inside the housing. The ferrules are then supported both with guide pins 80 in substrate 15 and cavities 140, 150 and 151 formed in the housing material.

In FIG. 3A, substrate 15 routes the light from sixteen fibers from ferrule 160 with a footprint of two rows of eight fibers in eight respective waveguides 20 parallel to the X-axis to two ferrules 70 each with a footprint of one row of eight fibers. The two rows of eight fibers are separated in ferrule 165 by a predefined distance. Two levels of waveguide 20 leaving the ferrule with a footprint of two rows of eight waveguides in cavity 140 are physically at different heights separated in the Z-direction by the predefined distance of two rows of the fiber facets in the footprint of ferrule 165, which is incorporated into the design and fabrication of substrate 15. As a result, the one row of eight micro-lenses 13 in cavity 150 on face 152 and the one row of eight micro-lenses 13 in cavity 151 on face 158 are offset by the same predefined distance along the Z-axis.

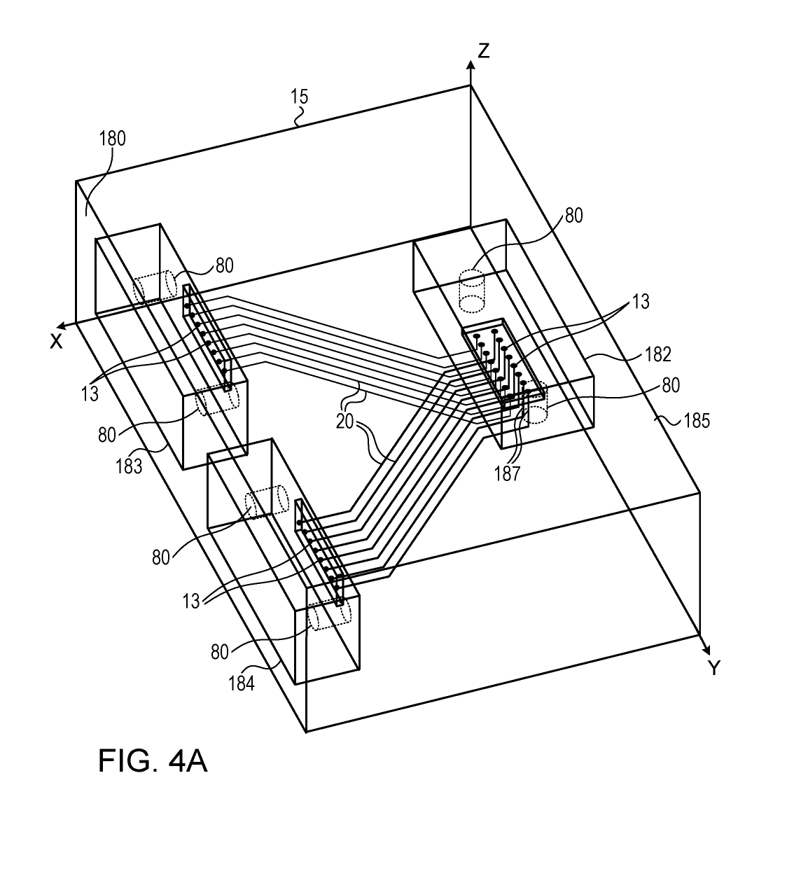

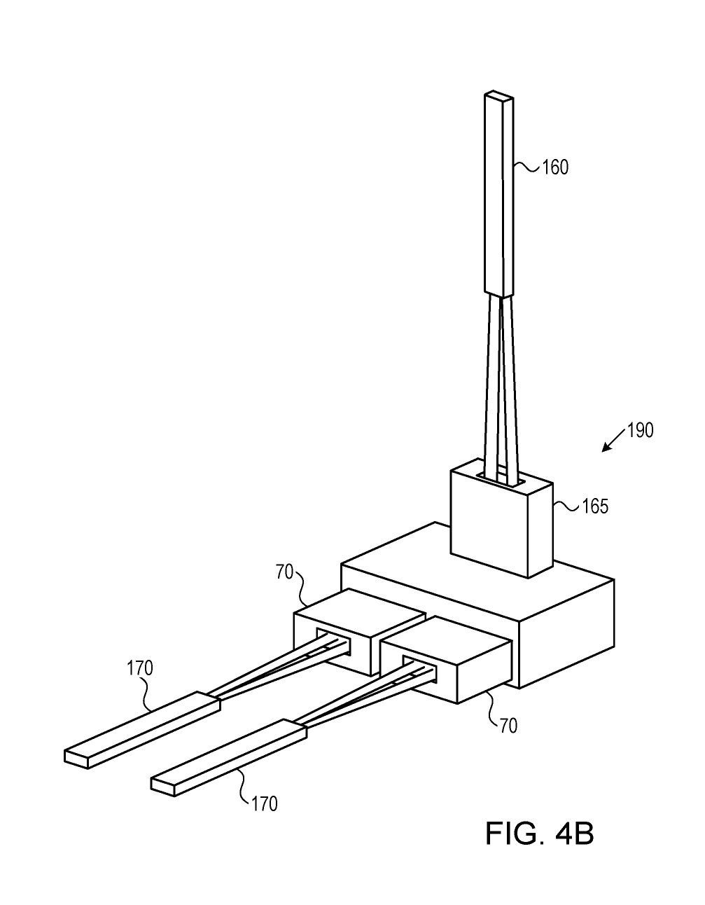

FIGS. 4A and 4B are diagrams showing an L-shaped optical splitter module 190, in accordance with another embodiment of the present invention. FIG. 4A shows substrate 15 where a cavity 182 is formed on a top face 185 of substrate 15 in order to support ferrule 165 with two rows of eight fibers. Similarly, two cavities 183 and 184 are formed in a left face 180 of substrate 15 to support ferrule 70 with one row of eight fibers.

For the embodiment shown in FIG. 4A, two levels of eight waveguides 20 are formed in substrate 15, which is configured to split the light in the two rows of sixteen fibers in ferrule 165 inserted into cavity 182 to two ferrules 70 with one row of eight fibers inserted in cavities 183 and 184. In each cavity 182, 183 and 184, guide pins 80 are formed in the substrate and inserted into guide pin channels 85 formed in the body of the ferrule so as to position the end of the fiber facets 55 precisely with a gap G distance from a respective array of micro-lenses 13.

Most of the length of waveguides 20 extends within a single plane. In this single plane, each waveguide has two bend points, one close to cavity 182 and the other close to cavity 184 or cavity 183. In this embodiment, all the waveguides in a first group, connecting cavities 182 and 183 have the same length and extend in parallel. Optionally, also all the waveguides in a second group, connecting cavities 182 and 183 have the same length. Possibly, although not necessarily, the waveguides of both the first and second groups have the same length. It is noted that close to cavity 182, waveguides 20 have a vertical bend which leads the waveguides out of the single plane to cavity 182.

FIG. 4B shows L-shaped optical splitter module 190 where cavity 182 is configured to support multi-fiber ferrule 165 holding sixteen optical fibers that are arranged in a footprint of two rows of eight fibers. Individual fibers 60 are held in the optical cables. First optical cable 160 is configured to connect to the footprint of ferrule 165. Cavities 183 and 184 are configured to support multi-fiber ferrule 70 holding eight optical fibers that are arranged in a footprint of one row of eight fibers within the ferrule housing supported by two ferrule guide pins 80. Two optical cables 170 are configured to connect to the footprint of the two respective ferrules 70 at left face 180 supported in cavities 183 and 184 formed in substrate 15.

In some embodiments, L-shaped optical splitter module 190 as shown in FIG. 4B is formed directly from substrate 15 with support pins 80, and support cavities 182, 183, and 184 for the ferrules. In other embodiments, module 190 can be fabricated by forming cavities 182, 183, and 184 in any suitable housing material where substrate 15 is placed inside the housing. The ferrules are then supported both with guide pins 80 in substrate 15 and cavities 182, 183, and 184, which are formed in the housing material.

For optical fiber splitter module 190 shown in FIGS. 4A and 4B, two rows of eight micro-lenses 13 focus the light from the two-row footprint of eight fibers in ferrule 165 inserted into cavity 182 to waveguides 20 in substrate 15. However, the light is directed vertically in a vertical portion 187 of waveguide 20 parallel to the Z-axis in FIG. 4A. The vertical portion 187 of waveguide 20 has a vertical orientation vector which is then rotated horizontally into the XY plane by a vertical to horizontal bend, or any suitable transition.

Vertical waveguide 187 can be formed by filled waveguides in substrate 15 by etching vertical vias in the substrate material layers that are filled with an suitable optical material with a higher index of refraction than the substrate material. Similarly the vertical to horizontal waveguide bend which rotates vertical portion 187 of waveguide 20 into waveguides 20 oriented in the X-Y plane can be formed using any of the reflectors shown in the embodiments of FIGS. 2A-2D, or any suitable vertical to horizontal transition.

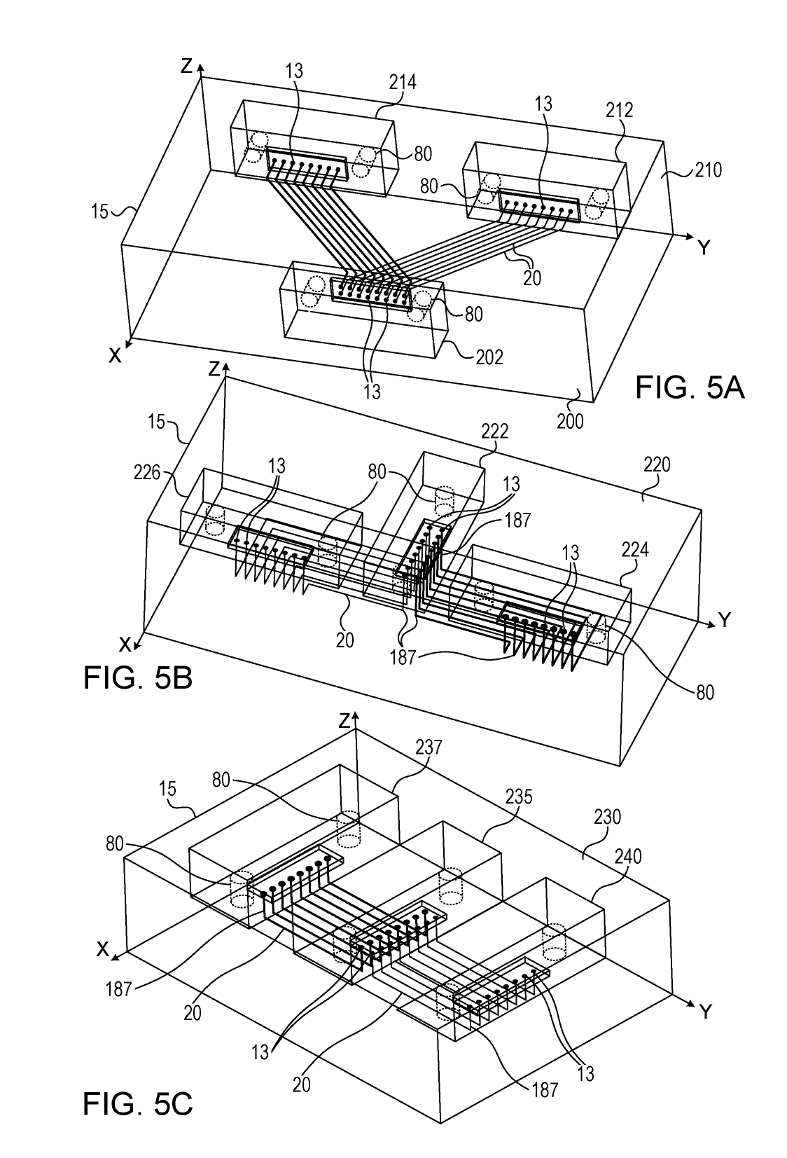

FIGS. 5A-5C are diagrams showing three optical splitter module configurations, in accordance with embodiments of the present invention. FIG. 5A shows a planar optical splitter configuration where three ferrules are mounted on two XY planes located at different X-positions. FIGS. 5B and 5C show optical splitter configurations in which all three ferrule connectors are on the same top face of the splitter module with the ferrules at different orientations on the top face. FIGS. 5A-5C show only substrate 15 and the routing of internal waveguides 20 to illustrate the different module configurations.

In the first embodiment shown in FIG. 5A, a planar optical splitter configuration is shown where the optical ferrule connectors are oriented perpendicular to the X axis. On a front face 200 of substrate 15, a cavity 202 is formed to support multi-fiber ferrule 165 holding sixteen optical fibers that are arranged in two rows of eight fibers within the ferrule housing supported by two ferrule guide pins 80 also formed in the substrate. Similarly on a back face 210, two cavities 212 and 214 are formed in substrate 15 perpendicularly to the X-axis to accommodate two ferrules 70, each with one row of eight fibers.

Optionally, in the embodiment of FIG. 5A, each waveguide 20 is included entirely in a single plane. The waveguides connecting cavity 202 to cavity 214 are located in a first plane, while the waveguides connecting cavity 202 to cavity 212 are in a second plane.

In the second embodiment shown in FIG. 5B, an optical splitter configuration is shown where the optical ferrule connectors are on a same top face 220 oriented perpendicularly to the Z axis. A cavity 222 is formed to support multi-fiber ferrule 165 holding sixteen optical fibers that are arranged in two rows of eight fibers within the ferrule housing supported by two ferrule guide pins 80 also formed in the substrate. Similarly, two cavities 224 and 226 are formed in substrate 15 to accommodate two ferrules 70, each with one row of eight fibers. However, the two rows on micro-lenses 13 in cavity 222 are oriented parallel to the X-axis, and the one row of micro-lenses 13 in cavities 224 and 226 are oriented parallel to the Y axis as shown in FIG. 5B.

In the embodiment of FIG. 5B, the waveguides include both vertical bends leading to the cavities 222, 224 and 226 and horizontal bends to match the different orientation of cavities 224 and 226 relative to cavity 222. While the horizontal bends may be in two different planes, e.g., one for the waveguides leading to cavity 224 and one for the waveguides leading to cavity 226, in some embodiments all the horizontal bends are in a single plane.

Finally in the third embodiment shown in FIG. 5C, an optical splitter configuration is shown where the cavities to support the optical ferrule connectors are on a same top face 230 oriented perpendicularly to the Z axis. A cavity 235 is formed to support multi-fiber ferrule 165 holding sixteen optical fibers that are arranged in two rows of eight fibers within the ferrule housing supported by two ferrule guide pins 80 also formed in the substrate. Similarly, two cavities 237 and 240 are formed in substrate 15 to accommodate two ferrules 70, each with one row of eight fibers. However, the two rows on micro-lenses 13 in cavity 222 are oriented parallel to the X-axis, and the one row of micro-lenses 13 in cavities 224 and 226 are also oriented parallel to the X axis as shown in FIG. 5C.

In the embodiment of FIG. 5C, the waveguides only have vertical bends.

For the embodiments shown in FIGS. 5B and 5C, both vertical 187 waveguides (orientation vector parallel to the Z-axis) and horizontal waveguides (orientation vector in the X-Y plane) are formed in substrate 15 by the methods previous described in order to realize the embodiments shown here.

In the exemplary embodiments shown in the foregoing figures, optical interface 30 and the ferrules are oriented along Cartesian axes. This orientation is shown merely for the sake of visual clarity and not by way of limitation of the embodiments of the present invention. Optical interface 30 may alternatively be configured at any suitable angle relative to substrate 15. The optical interface may be configured to couple light between a waveguide in the substrate and a fiber in the ferrule at any desired angle, for example, by cutting substrate 15 at an appropriate bevel angle, forming micro-lenses 13 on the beveled edge of the substrate, and positioning the ferrule on the bevel. Any suitable fabrication technique and materials may be used to form a beveled optical interface so as to support a ferrule mounted at any suitable angle relative to the body of the optical fiber splitter module.

Optical interface 30 as described in the embodiments of the present invention is not limited to optical fiber splitter modules. The light in the array of waveguides 20 may be directed by optical interface 30 in interconnect 10 into any suitable optical element in accordance with the embodiments of the present invention shown in FIG. 1 as previously described. Interface 30 is designed where in place of the multi-fiber ferrule 70 shown in FIG. 1, any suitable optical element may be mounted at the same plane of fiber facets 55. Thus by varying parameters D from the edge 50 of waveguide 20 and gap G from the micro-lens 13 to the optical element focuses the light diverging from edge 50 onto the optical element.

An exemplary configuration to illustrate this embodiment may comprise, for example, the light in sixteen fibers held in a ferrule 165 are coupled into two levels of waveguide 20 in substrate 15 and are split into two stacked levels of eight waveguides in substrate 15 as shown in FIG. 3A. However, each level of eight waveguides arrives to two opposite faces of the substrate as in cavities 150 and 151. However in place of ferrules in the respective cavities, an optoelectronic transducer array of eight Vertical Cavity Surface Emitting Lasers (VCSEL) devices on a first chip and an array of eight photodiode (PD) devices on a second chip may be mounted at gap distance G from micro-lenses 13. Alternatively, any other suitable type of optical emitters and optical detectors can be used.

Similarly the waveguide may terminate at a distance D from the edge of the substrate faces where the PD and VCSEL array chips are mounted in substrate 15 (in place of ferrule 70 in cavities 150 and 151). The optical interface is designed in accordance with the embodiments of the present invention shown in FIG. 1 as previously described.

It is noted that in addition to the waveguides 20, substrate 15 may include additional optical elements, such as fiber splitters and an optical power monitor.

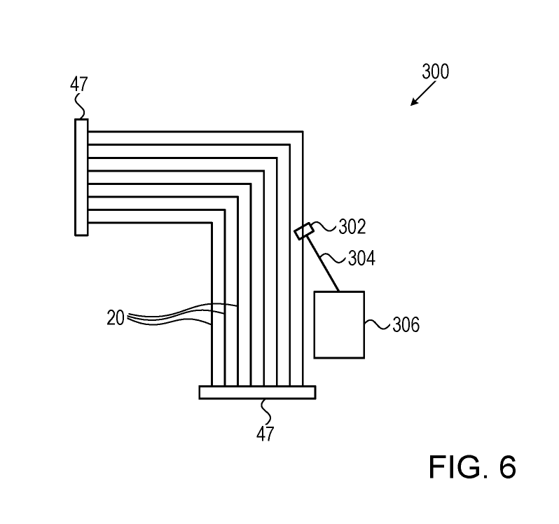

FIG. 6 is a schematic illustration of an optical interconnect 300, in accordance with an embodiment of the invention. In addition to waveguides arranged in a manner similar to those in optical interconnect 10 of FIG. 1, interconnect 300 comprises a light splitter 302 on an outer waveguide. Light splitter 302 leads a portion of the light passing in the outer waveguide into a side waveguide 304, which leads to a light monitor 306. Light splitter 302 may be of any type known in the, for example as described in US patent publication 2011/0150390 to Meyer et al., titled “In-Plane Optical Wave Guide with Area Based Splitter”, which is incorporated herein by reference.

Although only a single splitter 302 is shown, the optical interconnect may include a plurality of splitters on a plurality of the waveguides, for example on more than 35% of the waveguides or even on all the waveguides. Side waveguide 304 optionally extends in a same plane as includes waveguides 20. Alternatively, side waveguide 304 connects splitter 302 to a different plane than includes waveguides 20.

Although the embodiments described herein mainly address a low loss optical interface for coupling light in fibers between fiber bundles in input/output ferrules in an optical splitter module, the optical interface described herein can also be used in other applications, for precision coupling light in a fiber to any suitable optical element through a micro-lens array.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An optical interconnect to direct optical signals between first and second ferrules of optical fibers, comprising:
a substrate;
a first optical interface, configured to connect to the first ferrule of optical fibers, located on a first face of the substrate;
a second optical interface, configured to connect to the second ferrule of optical fibers, located on a second face of the substrate;
a plurality of optical waveguides, which are formed in the substrate and are configured to convey respective optical signals between the first optical interface and the second optical interface;
one or more first micro-lenses, which are disposed on respective first ends of the optical waveguides and are configured to couple the optical signals between the first ends and the first ferrule; and
one or more second micro-lenses, which are disposed on respective second ends of the optical waveguides and are configured to couple the optical signals between the second ends and the second ferrule,
wherein each of the plurality of waveguides includes at least one horizontal bend and wherein the at least one horizontal bends of the plurality of waveguides are included in a single plane.

2. The optical interconnect according to claim 1, wherein the first micro-lenses are disposed on a face of the substrate, and wherein the first ends of the optical waveguides terminate at a predefined distance from the face of the substrate, opposite the first micro-lenses.

3. The optical interconnect according to claim 1, and comprising a mechanical fixture that fixes the first optical elements at a predefined distance from the respective first micro-lenses, so as to form an air gap between the first optical elements and the first micro-lenses.

4. The optical interconnect according to claim 1, wherein the at least one horizontal bend of each of the plurality of waveguides bends at least 30° off a straight line.

5. The optical interconnect according to claim 1, wherein each optical waveguide comprises a plurality of horizontal bends within the single plane.

6. The optical interconnect according to claim 1, wherein the plurality of optical waveguides include optical waveguides having different lengths.

7. The optical interconnect according to claim 1, wherein the plurality of optical waveguides include optical waveguides having different lengths within the single plane.

8. The optical interconnect according to claim 1, comprising a third optical interface and an additional plurality of optical waveguides formed in the substrate and configured to convey respective optical signals between the first optical interface and the third optical interface, wherein the additional plurality of optical waveguides includes respective bends includes in an additional single plane.

9. The optical interconnect according to claim 1, wherein the optical waveguides comprise waveguides formed in the substrate by etching grooves on the layers of optical materials, filling the etched grooves with a second optical material with an index of refraction higher than that of the layers, and subsequently bonding the layers together.

10. The optical interconnect according to claim 1, wherein the first face is parallel with the second face.

11. The optical interconnect according to claim 1, wherein the first face is perpendicular to the second face.

12. The optical interconnect according to claim 1, wherein the plurality of optical waveguides include optical reflectors formed in the waveguides to implement the horizontal bends.

13. The optical interconnect according to claim 12, wherein the optical reflectors formed in the waveguides comprise parabolic optical reflectors.

14. The optical interconnect according to claim 12, wherein the optical reflectors formed in the waveguides comprise straight optical reflectors.

15. The optical interconnect according to claim 12, wherein the optical reflectors formed in the waveguides comprise curved concave optical reflectors.

16. The optical interconnect according to claim 12, wherein the optical reflectors comprise optical reflectors formed by etching the waveguides in the substrate.

17. A method for forming an optical interconnect to direct optical signals between first and second ferrules of optical fibers, comprising:
providing a substrate;
forming in the substrate a plurality of optical waveguides, for conveying respective optical signals between first ends and second ends of the optical waveguides;
disposing one or more first micro-lenses on the respective first ends of the optical waveguides, for coupling the optical signals between the first ends and respective first optical elements; and
disposing one or more second micro-lenses on the respective second ends of the optical waveguides, for coupling the optical signals between the second ends and respective second optical elements,
wherein each of the plurality of waveguides includes at least one horizontal bend and wherein the at least one horizontal bends of the plurality of waveguides are included in a single plane.

18. The method according to claim 17, wherein disposing the first micro-lenses comprises placing the first micro-lenses on a face of the substrate, and wherein forming the optical waveguides comprises terminating the first ends of the optical waveguides at a predefined distance from the face of the substrate, opposite the first micro-lenses.

19. The method according to claim 17, wherein forming the optical waveguides comprises forming waveguides each including a plurality of horizontal bends.

20. The method according to claim 17, wherein forming the optical waveguides comprise forming optical waveguides having different lengths.

21. The method according to claim 17, wherein forming the optical waveguides comprise forming a first subset of the optical waveguides whose second ends lie on a first face of the substrate, and forming a second subset of the optical waveguides whose second ends lie on a second face of the substrate, different from the first face.
